(19) United States
(12) Patent Application Publication
(10) Pub. No.: US 2004/0238109 A1
(43) Pub. Date: Dec. 2, 2004

(54) Masking tape tool/dispenser

(76) Inventor: George C. Gonzalez, Rockledge, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/794,451

(22) Filed: Mar. 6, 2004

Related U.S. Application Data
(60) Provisional application No. 60/452,624, filed on Mar. 6, 2003.

(51) Int. Cl. B32B 31/00; B65C 1/00

(52) U.S. Cl. 156/227; 156/443

(57) ABSTRACT

A masking tape tool/dispenser for imparting a lengthwise fold in a length of masking tape. Within the tool, the tape traverses proximate or through a plurality of tape guides for imparting the fold in the tape, such that a first lengthwise region of the adhesive surface is folded against a second lengthwise region of the adhesive surface, leaving sufficient exposed adhesive surface to permit adhesion of the folded tape to a work piece for paint overspray masking. The user can withdraw a continuous length of the folded masking tape from the dispenser, cutting the folded tape when the desired length has been withdrawn. During use, the tool can be hand-held or releasably affixed to a surface.

The present invention claims the benefit of the provisional patent application entitled, Masking Tape Tool/Dispenser, filed on Mar. 6, 2003 and assigned application No. 60/452,624.

### FIELD OF THE INVENTION

The present invention relates to a masking tape dispenser, and more particularly, to a masking tape dispenser that dispenses a length of masking tape wherein a portion of the adhesive surface of the masking tape is folded back onto the adhesive surface.

### BACKGROUND OF THE INVENTION

In the auto-body repair and paint industry, masking tape is used in enormous quantities during the process of finishing and painting a vehicle. The tape is used in a variety of different lengths depending upon the surface to be masked. One of the final stages in painting the vehicle, and one very important step, is a careful masking of the vehicle to prevent overspray into unwanted areas during the paint spraying process. For example, the windows, mirrors, tires, door jambs (also referred to as trim edges) and bumpers (if they are not being painted) are masked to prevent the application of paint to those surfaces. It is also desirable to mask the inside surface of the door jambs, the underside of the trunk lid, and any jambs not being painted, such that paint is applied only to the body areas that are exposed when the door or the trunk is closed.

The use of conventional masking tape to mask these areas prior to spray painting is known. Masking tape comprises an elongated substrate having a first adhesive surface and a second oppositely disposed non-adhesive surface. The adhesive surface easily bonds to most materials, but advantageously can also be easily removed. The tape is supplied in roll form, wherein a length of the tape is wound about a circular roll and dispensed therefrom by grasping the free end and unrolling the desired tape length from the roll.

When used to demark an area to be painted from an area to remain unpainted, as described above, the masking tape forms an undesirable paint edge as the paint accumulates against a masking tape edge during the spraying process. When the tape is removed, the paint edge is particularly noticeable and is generally considered visually objectionable. To avoid the paint build-up and the attendant paint edge, it is known to fold a portion of an adhesive surface 10 of a masking tape length 12 back onto the adhesive surface 10 to form a folded region 14 as illustrated in FIG. 1. The tape length 12 further comprises a non-adhesive surface 13.

As illustrated in FIG. 2, the tape length 12 separates an unpainted region 20 from a painted region 22 of an object 24. A folded edge 24 of the tape length 12 is positioned facing in a direction of the painted region 22. As paint is sprayed onto the region 22, a certain amount of paint accumulates under the folded edge 24, with more paint accumulating along an outward edge 30 and less paint accumulating along an inner region 32. See FIG. 1. As a result, the paint is tapered or feathered from the painted region 22 to the unpainted region 20, eliminating the objectionable paint edge. This technique is typically utilized in an automotive door and trunk lid jamb, as well as fender and quarter panel jambs, to present a gradually tapering region between the painted outside surface and the unpainted inside jamb surface. When folded tape is used, the paint repair is not noticeable and the vehicle appears to have its original factory paint job.

Although the results according to the aforedescribed method are desired, forming the masking tape into the configuration illustrated in FIG. 1 is not trivial. The painter must grasp a length of tape in one hand, fold a section of the adhesive surface back onto the adhesive surface and position his fingers of one hand appropriately to continue folding the tape as he pulls additional tape from the roll with his other hand. As the painter pulls the tape, he must exercise caution to ensure that the tape does not become tangled with itself nor dragged along the floor, as such may affect the adhesive properties of the tape and cause failure of the tape to adhere to the surface to be painted. This manual folding process restricts the length of tape that can be folded in one continuous tape length, requiring the painter to serially piece folded tape lengths to form the boundary between the painted and unpainted regions. Forming the tape using this folding action is time consuming and requires much patience, practice and dexterity. This manual method is not easily learned and in fact many automotive body repair technicians are incapable of folding the tape according to this technique. Although it is possible to fold a length of tape by laying the tape on a surface with the adhesive side up, grasping and folding a portion of the adhesive surface back onto itself, this techniques is impractical, given the large quantity of making tape and the long lengths used in the automotive painting business.

### SUMMARY OF THE INVENTION

The present invention comprises, in one embodiment, a dispenser for forming a lengthwise fold along a tape edge, wherein the fold comprises a first lengthwise region of an adhesive surface folded against a second lengthwise region of the adhesive surface as the tape is withdrawn from a tape roll and traverses a tape path. The dispenser comprises a base and a rotatable hub oriented substantially horizontal to the base for receiving and supporting the tape roll, wherein the tape is withdrawn from the roll in a substantially vertical orientation relative to the base. A plurality of intermediate tape guides supported by the base plate and disposed along the tape path impart a curvature along a top tape edge as the tape traverses the tape path. A folding tape guide is disposed in the tape path following the plurality of intermediate tape guides. The folding tape guide comprises an open frame having first and second edges substantially parallel to the tape path and third and fourth edges substantially perpendicular to the tape path, wherein the first and second edges define a first channel therebetween. The folding tape guide further comprises a first tab extending from the first edge in a direction toward the second edge, and further comprises a second tab extending from the first tab to the second edge. An upper surface of the second tab is below an upper surface of the first tab. The tape path further comprises a path under the third edge into the first channel, above the first and the second tabs and under the fourth edge, and wherein a user draws the tape upwardly upon exiting the folding tape guide to form the fold.

The invention further comprises a method for folding tape having two parallel edges defining a tape width therebetween and comprising an adhesive surface and a non-adhesive surface, wherein a first portion of the adhesive surface extends from one tape edge is folded onto a second portion of the adhesive surface. A first step curves the first portion of the adhesive surface in a direction toward the adhesive surface. The tape is inserted into a tape guide comprising an open rectangular frame further comprising first and second members parallel to the tape edges and third and fourth cross members connected to the first and second members. The first and the second members define a channel therebetween having a width substantially equal to the tape width and further defining a notch within the channel. The tape is inserted under the first cross member and extends into the channel. The tape is drawn through the tape guide and under the second cross member, wherein the notch urges the curved edge onto the second portion of the adhesive surface to fold the tape edge.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 illustrates a folded section of masking tape;

FIG. 2 illustrates a spray painting application for the folded section of masking tape shown in FIG. 1;

FIG. 3 is a perspective view of the masking tape dispenser according to one embodiment of the present invention;

FIG. 4 is a top view of one embodiment of the masking tape dispenser of the present invention;

FIGS. 5 through 7 illustrate the successive folding stages as the tape passes through guides of the masking tape dispenser;

FIG. 8 is a partial cross-sectional view taken along a plane through FIG. 7;

FIG. 9 illustrates a perspective view of a masking tape dispenser according to another embodiment of the present invention; and

FIG. 10 is a close-up view of the tape of FIG. 9 during one stage of the folding process.

### DETAILED DESCRIPTION OF THE INVENTION

Before describing in detail the particular method and apparatus for forming a folded section of masking tape according to the present invention, it should be observed that the invention resides in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

The present invention folds a length of masking tape for use in masking a painted region 22 from an unpainted region 20, preventing a heavy edge or build-up of paint between the painted region 22 and the unpainted region 20 as illustrated above in FIG. 2. Such a folded length of tape (including tapes other than masking tape) may have a useful function for purposes other than masking between painted and unpainted regions. After installing a masking tape roll in a dispenser of the present invention, the user grasps the masking tape free end and pulls, with a minimal amount of force, the tape from the roll and through the dispenser, form a fold along one tape edge. For masking tape having a ¾″ width, a folded region of approximately ¼″ is formed. A cutter attached at an exit end of the tool allows the user to tear off a desired length of the folded masking tape. The tool is manually operated with no requirement for an electrical supply.

The presented figures illustrate elements of the masking tape dispenser, showing in particular a tape length as it passes through the various guides of the dispenser and is formed into the desired folded configuration.

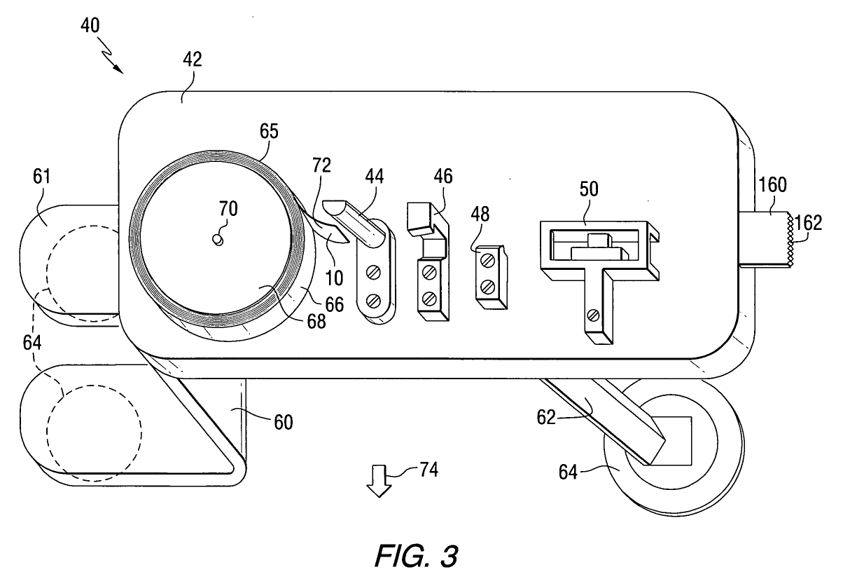

As shown in FIG. 3, a masking tape dispenser 40 (also referred to a masking tape tool) comprises a base 42 to which are affixed intermediate guides 44, 46, 48 and a folding tape guide 50. The base 42 and the guides 44, 46, 48 and 50 can be formed from various known materials, including Plexiglas®, fiberglass, other plastic materials, and metal materials and alloys. The intermediate guides 44, 46, 48 and a folding tape guide 50 can be affixed to the base 42 using conventional fasteners such as screws, bolts and nuts or an adhesive material, or by using other techniques and elements known in the art. In another embodiment, the base 42 and the guides 44, 46, 48 and 50 can be formed as a unitary structure, for example, by a mold process.

In one embodiment, legs 60, 61 and 62 extending from a bottom surface of the base 42 further comprise suction cups 64 for releasably attaching the dispenser 40 to a work surface, such as a floor or flat clean surface proximate the vehicle being painted. Other attachment techniques can also be used and are considered within the scope of the invention. The user can also hold the tape dispenser 40 in one hand while pulling the folded tape from an exit end with the other hand. The suction cups 64 can be removed and the masking tape dispenser 40 removably attached to a workbench or another work surface.

A tape roll 65 comprising an elongated length of tape 66 wound about the roll 65 (for example, masking tape having a width of about ¾″) is frictionally engaged over a hub or spool 68. The hub 68 is made to rotate in a clockwise direction about an axis 70 as the tape length 66 is withdrawn from the roll 65. A free end 72 withdrawn from the roll 65 is directed toward a guide 44, with the adhesive surface 10 facing a direction indicated by an arrowhead 74.

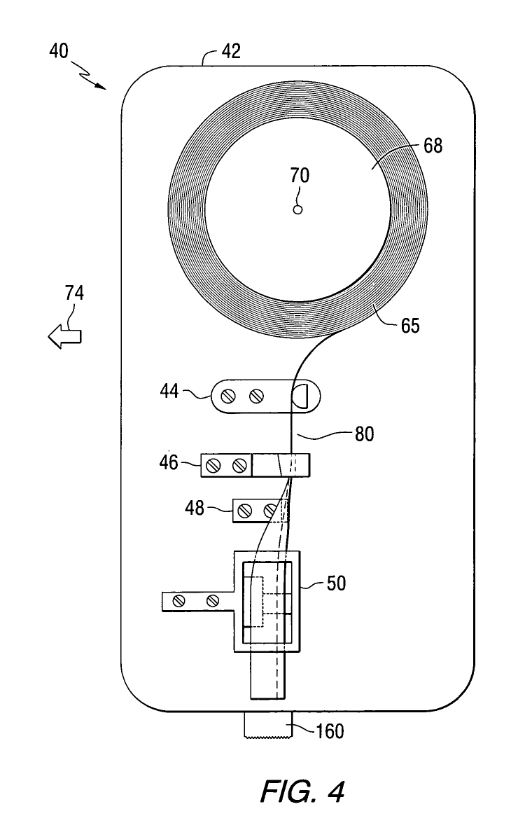

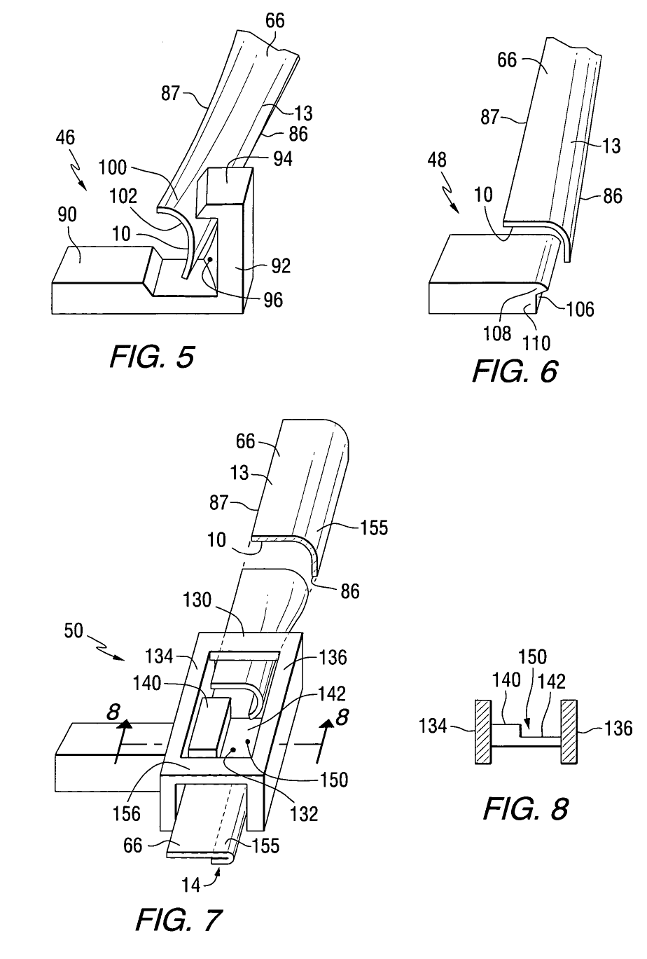

FIG. 4 is a top view of the base 42, generally indicating a tape path 80 through which the length of tape 66 passes proximate the guides 44, 46, 48 and 50. The guide 44 generally directs the tape 66 toward the guide 46. As the tape 66 exits the guide 46, the tape is beginning to curve in the direction 74. This curve is illustrated in FIG. 5, which also identifies a bottom edge 86 and a top edge 87 of the tape length 66. Generally, the guides 46 and 48 transition the tape orientation from a substantially vertical orientation as the tape 66 is fed from the roll 65, to a substantially horizontal orientation prior to entering the tape guide 50.

The guide 46 comprises a generally L-shaped structure (see FIG. 5) further comprising a base segment 90, a vertical segment 92 and a tab 94, which define a notch 96. As the tape length 66 is drawn through the guide 46, the tab 94 and the notch 96 force the tape to curve in the direction 74, causing the tape length 66 to begin to fold as a region 100 is folded in a direction of a region 102. Both regions 100 and 102 are on the adhesive side 10 of the tape length 66. Generally, a notch length is selected to impart the curve in the tape length 66, such that as the tape length 66 passes into the notch 96, the tape strikes the tab 94 causing the tape to curve as shown.

As shown in FIGS. 4 and 6, the tape fold becomes more pronounced as the tape passes the guide 48, which comprises a face 106 having an upper region 108 extending beyond (in a direction toward the tape 66) a lower region 110.

The tape 66 continues to curve along its length (i.e., lengthwise) as it enters the guide 50, passing under a member 130 (see FIG. 7) into a channel region 132 defined by two spaced-apart and substantially parallel members 134 and 136. A tab 140 and a tab 142 are disposed within the channel 132 and between the members 134 and 136. A top surface of the tab 140 is disposed above a top surface of the tab 142, such that the tab 140, the tab 142 and the member 136 form a notch 150. See the partial cross-sectional view of FIG. 8, taken along plane 8-8 of FIG. 7. As the tape 66 passes through the channel 132 and a tape region 155 passes through the channel 150, the region 155 continues to fold toward the adhesive surface 10, due to the force imparted along the tape width by the tab 140 and the tab 142. The unfolded portion of the tape 66 passes over the tab 140 and the folded portion passes through the notch 150.

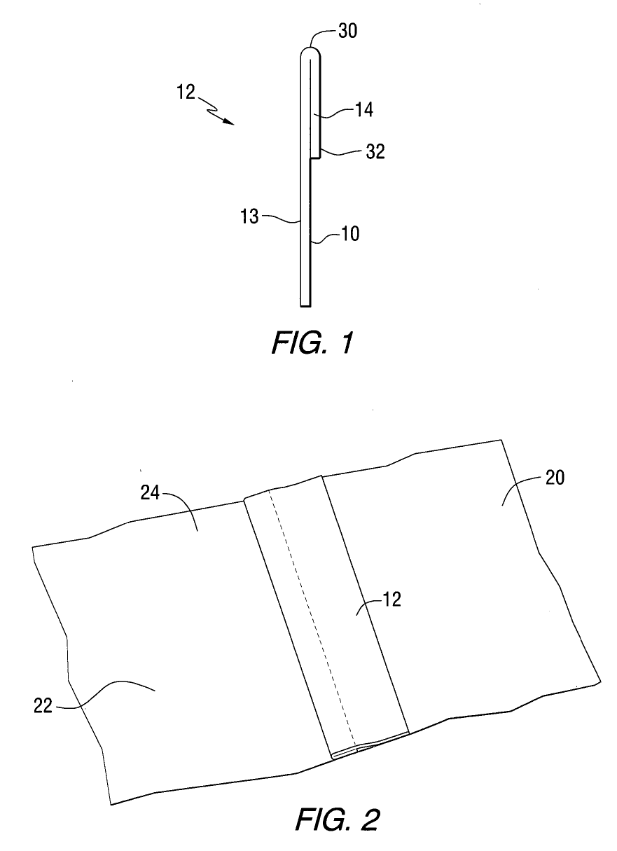

To complete the tape folding process, the user applies an upwardly directed force to the tape 66 as it passes under a member 156 and exits the guide 50. According to one embodiment, a distance between the base 42 and the member 130 is greater than a distance between the base 42 and the member 156 (i.e., the guide 50 is inclined downwardly in the direction of the tape path). The tape 66 is now in the configuration of FIG. 1, wherein the region 155 is folded against the adhesive surface 10 to form the folded region 14 as illustrated in FIG. 1. As the tape 66 exits the guide 50, the non-adhesive surface 13 is facing upward and the adhesive surface 10 is facing down.

The desired length of tape is cut from the roll 65 when the user urges the tape 66 against a cutting device 160 that is shown in FIG. 3. In one embodiment, the cutting device comprises a serrated edge 162.

In one embodiment the tape dispenser 40 accommodates masking tape having a width of about ¾.″ In such an embodiment the width of the channel 132 is approximately equal to the tape width. In this embodiment, the folded region 14 comprises a width of about ¼,″ leaving about ½″ of the adhesive surface 13 to be applied to the desired surface for masking prior to painting. In a preferred embodiment, the width of the notch 150 is approximately equal to the width of the folded region 155 of the tape.

To load the tape dispenser 40, the tape roll 65 is loaded on the hub 68 and the length of tape 66 is withdrawn in a clockwise direction from the roll 65. The tape length 66 is then extended about one inch beyond the end of the base 42. A short section across a width of the tape at a free end of the tape length 66 is folded back against the adhesive surface 10. With the non-adhesive surface 13 facing upward, the end of the tape 66 is threaded under the member 130, into the channel 132 and under the member 156. The remaining length of tape 66 is positioned proximate the guide 44, within the notch 96 of the guide 46 and proximate the face 106 of the guide 48. The length of tape is now folded as described above as the user exerts an upwardly directed force on the tape 66 exiting the guide 50.

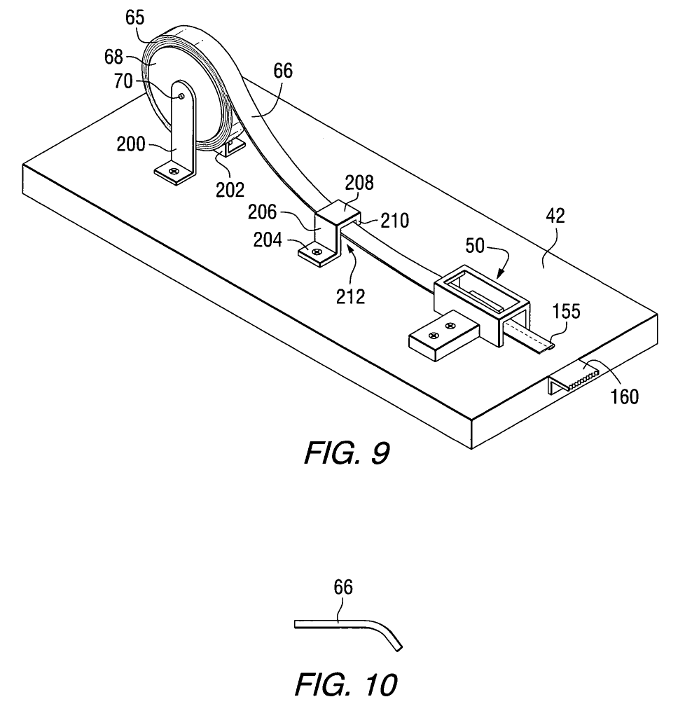

FIG. 9 illustrates another embodiment of the present invention wherein the tape roll 65 is oriented vertically with respect to the base 42. The hub 68 is rotatably affixed to two supports 200 and 202 for supporting the roll 65 in the position as illustrated. The tape 66 is withdrawn from the roll 65 in a substantially horizontal orientation relative to the base 42. A guide 204 comprises a vertical member 206 affixed to the base 42, a horizontal member 208 connected to the vertical member 206 and a tab 210 connected to the horizontal member 208. The vertical member 206, the horizontal member 208 and the tab 210 define a notch 212 for receiving the tape 66. A notch length is less than a tape width, causing the tape to curve downwardly as it passes through the notch 212. See FIG. 10. The tape 66 then enters the guide 50 for completing the folding process as described above.

As described above, using masking tape processed through the masking tape dispenser 40 eliminates heavy paint build-up in the door jambs/trim edges. The invention can also be advantageously employed for a two tone or two color paint job. When painting a two-tone color scheme, the two regions are masked, creating a heavy paint build up or crease between the two color regions. Use of the folded tape formed according to the teachings of the present invention, allows the paint to be applied such that the crease is replaced with a misty or feathered edge. With the crease absent, pinstripes can be easily applied over the area where the two colors join, leaving a factory finish.

The invention can also be utilized during the process of applying road guard/chip guard to a bottom vehicular surface. During the process of applying the material, the painter is faced with the obvious build-up of the sprayed material. By using the invention to form the folded tape for masking, the painter eliminates a jagged edge that is caused due to the road guard/chip guard being excessively thick at the sprayed edge.

An apparatus and method useful for forming a folded length of masking tape has been described. Specific applications and exemplary embodiments of the invention have been illustrated and discussed, providing a basis for practicing the invention in a variety of ways and in a variety of embodiments. Numerous variations are possible within the scope of the invention. Features and elements associated with one or more of the described embodiments are not to be construed as required elements for all embodiments. The invention is limited only by the claims that follow.

What is claimed is:

1. A dispenser for forming a lengthwise fold along a tape edge, wherein the fold comprises a first lengthwise region of an adhesive surface folded against a second lengthwise region of the adhesive surface as the tape is withdrawn from a tape roll and traverses a tape path, the dispenser comprising;
a base;
a rotatable hub oriented substantially horizontal to the base for receiving and supporting the tape roll, wherein the tape is withdrawn from the roll in a substantially vertical orientation relative to the base;
a plurality of intermediate tape guides supported by the base plate and disposed along the tape path for imparting a curvature along a top tape edge as the tape traverses the tape path;
a folding tape guide disposed in the tape path following the plurality of intermediate tape guides, wherein the folding tape guide comprises an open frame having first and second edges substantially parallel to the tape path and third and fourth edges substantially perpendicular to the tape path, wherein the first and second edges define a first channel therebetween;
wherein the folding tape guide further comprises a first tab extending from the first edge in a direction toward the second edge, and further comprises a second tab extending from the first tab to the second edge, and wherein an upper surface of the second tab is below an upper surface of the first tab; and
wherein the tape path further comprises a path under the third edge into the first channel, above the first and the second tabs and under the fourth edge, and wherein a user draws the tape upwardly upon exiting the folding tape guide to form the fold.

2. The dispenser of claim 1 wherein the folding tape guide further comprises a rectangular structure wherein the first and the second sides are substantially perpendicular to the third and the fourth sides.

3. The dispenser of claim 1 wherein a notched guide of the plurality of intermediate guides comprises a vertical member defining a notch therein, wherein as the tape passes through the notch, the curvature is imparted in the top edge thereof.

4. The dispenser of claim 3 wherein a length of the notch is less than a tape width.

5. The dispenser of claim 3 wherein the plurality of intermediate guides transition a tape orientation from a substantially vertical orientation as the tape is fed from the roll, to a substantially horizontal orientation prior to entering the folding tape guide.

6. The dispenser of claim 1 further comprising a tape cutting element comprising a cutting edge for exerting a cutting force against the tape to separate a length of folded tape from the tape roll.

7. The dispenser of claim 1, wherein a material of the intermediate tape guides and the folding tape guide comprises a molded plastic material.

8. The dispenser of claim 1 further comprising an attachment element for releasably attaching the dispenser to a support surface.

9. The dispenser of claim 8 wherein the attachment element comprises a suction cup affixed to a bottom surface of the base.

10. The dispenser of claim 8 further comprising at least two legs supported by a bottom surface of the base, wherein a suction cup is supported by each leg, the suction cup for releasably attaching the dispenser to the support surface.

11. The dispenser of claim 1 wherein the tape comprises masking tape.

12. The dispenser of claim 1 wherein a distance between the third edge of the folding tape guide and the base is greater than a distance between the forth edge and the base.

13. The dispenser of claim 1 wherein the folding tape guide is inclined downwardly in a direction of the tape path.

14. The dispenser of claim 1 wherein the plurality of intermediate tape guides comprises a first tape guide for generally directing the tape from the roll along the tape path.

15. The dispenser of claim 14 wherein the plurality of intermediate tape guides further comprises a second tape guide comprising a vertical member defining a notch therein, wherein as the tape passes through the notch, the curvature is imparted in the top edge thereof.

16. The dispenser of claim 15 wherein the plurality of intermediate tape guides further comprises a third tape guide comprising a surface extending into the tape path, wherein the surface further comprises a first face and a second face, wherein the second face is recessed away from the tape path relative to the first face.

17. A dispenser for dispensing masking tape from a roll, wherein the tape comprises an adhesive surface and is fed from the roll along a tape path for forming a lengthwise fold in the adhesive surface, the dispenser comprising;
a base;
a rotatable hub supported by the base and oriented substantially upright relative to the base for receiving and supporting the roll, wherein a tape length is dispensed from the roll in a substantially horizontal orientation relative to the base;
a first guide for receiving the tape length and for imparting a downwardly directed lengthwise curve therein; and
a second guide defining a channel therein for receiving the tape length from the first guide, wherein a channel width is substantially equal to a tape width, and further comprising a member extending across the channel, the member comprising first and second surfaces facing upwardly relative to the base, and wherein the first surface is elevated above the second surface, and wherein a width of the second surface is approximately equal to a width of the fold, and wherein the first and the second surfaces cooperate to impart the tape fold as a user draws the tape through the second guide.

18. A method for folding tape having two parallel edges defining a tape width therebetween and comprising an adhesive surface and a non-adhesive surface, wherein a first portion of the adhesive surface extending from one tape edge is folded onto a second portion of the adhesive surface, the method comprising:
curving the first portion of the adhesive surface in a direction toward the adhesive surface;
inserting the tape into a tape guide comprising an open rectangular frame further comprising first and second members parallel to the tape edges and third and fourth cross members connected to the first and second members, wherein the first and the second members define a channel therebetween having a width substantially equal to the tape width and further defining a notch within the channel, and wherein the tape is inserted under the first cross member and extends into the channel; and
drawing the tape through the tape guide and under the second cross member, wherein the notch urges the curved edge onto the second portion of the adhesive surface to fold the tape edge.
